(19) United States
(12) Patent Application Publication
(10) Pub. No.: US 2008/0161735 A1
(43) Pub. Date: Jul. 3, 2008

(54) MICRONEEDLE ROLLER

(76) Inventors: Justin Lee, Tustin, CA (US); Soon Il Hong, Si-heung-si (KR)

Correspondence Address: PARK LAW FIRM, 3255 WILSHIRE BLVD, SUITE 1110, LOS ANGELES, CA, 90010, US

(21) Appl. No.: 11/961,040

(22) Filed: Dec. 20, 2007

(30) Foreign Application Priority Data
Dec. 20, 2006 (KR) 10-2006-0131238

(51) Int. Cl. A61H 15/00

(52) U.S. Cl. 601/125; 601/119

(57) ABSTRACT

A microneedle roller includes a plurality of discs, each of which comprises a first side surface, a second side surface and a center hole. The first side surface comprises a plurality of radial grooves, and the discs are stacked on one another in a way that the first side surface of one disc contacts the second side surface of the adjacent disc. The microneedle roller further includes a plurality of microneedles that are received in the radial grooves of the disc, and each of which has a pointed end. The pointed end protrudes beyond the outer circumference of the disc. The microneedle comprises an elongated cylindrical needle shank, a first sloped portion that starts from the pointed end, and a second sloped portion that is provided between the first sloped portion and the second sloped portion. The angle of the first sloped portion is greater.

### CLAIMING FOREIGN PRIORITY

The applicant claims and requests a foreign priority, through the Paris Convention for the Protection of Industrial Property, based on patent applications filed in the Republic of Korea (South Korea) with the filing date of Dec. 20, 2006 with the patent application number 10-2006-0131238 by the applicant, the contents of which are incorporated by reference into this disclosure as if fully set forth herein.

### BACKGROUND OF THE INVENTION

The present invention relates to a microneedle roller.

More particularly, the present invention relates to a microneedle roller that reduces pain of the skin, has durable microneedles, and stimulates the skin uniformly.

The skin of a human being is composed of three primary layers, the epidermis, the dermis and the appendages. Among them, the dermis forming skin wrinkles is disposed under the epidermis as the lowest skin layer at a thickness of about 0.7 mm to 4 mm. Collagen in the dermis shrinks as the aging proceeds. As the result, the skin gets dry, and more skin wrinkles appear. In order to prevent wrinkles from appearing and to keep the skin tight, it is needed to induce the skin to create more collagen or to inject collagen into the skin.

When nutrients required for forming collagen like Vitamin C or peptide are spread or sprayed on the skin, only 0.3% of such nutrients pass through the skin, and the remaining 99.7% remains on the skin, dried and removed away.

Microneedle therapy system (MTS) is used to eliminate such problem. MTS is a device to supply nutrients required to create collagen to the dermis by stimulating the skin or by forming micro channels in the skin using a roller with micro needles projected therefrom.

The thickness of the epidermis is about 0.03 mm to 1 mm. The exposed ends of the micro needles penetrate the epidermis, thereby forming micro channels to the dermis. The nutrients can be effectively supplied to the dermis through the micro channels for sustaining the skin tight or for preventing wrinkles from appearing.

Minute wounds are formed in the skin with the micro needle roller, and the skin is stimulated and creates collagen by natural curing process of the skin, thereby reproducing the skin. That is, collagen is formed by natural curing process and restores the aged skin without hurting the epidermis like laser peeling operation.

Microneedle rollers by prior art have disadvantages that they induce acute pain to the skin since their ends are too sharp, the ends of the microneedle rollers are not durable, the skin is not stimulated uniformly, and the microneedles fall off from the roller. The microneedle roller should be disposed together with the handle since it is difficult to separate the roller from the handle.

### SUMMARY OF THE INVENTION

The present invention contrives to solve the disadvantages of the prior art.

An objective of the invention is to provide a microneedle roller that induces substantially less pain to the skin and having durable microneedles.

Another objective of the invention is to provide a microneedle roller that has good maintainability.

In order to achieve the above objective, the present invention provides a microneedle roller that includes a plurality of discs, each of which comprises a first side surface, a second side surface and a center hole. The first side surface comprises a plurality of radial grooves, and the discs are stacked on one another in a way that the first side surface of one disc contacts the second side surface of the adjacent disc, The microneedle roller further includes a plurality of microneedles that are received in the radial grooves of the disc, and each of which has a pointed end. The pointed end protrudes beyond the outer circumference of the disc.

The microneedle roller further includes an axis shaft that passes thorough the center holes of the stacked discs; and a handle that detachably supports both ends of the axis shaft. The pointed end of the microneedle is rounded.

The microneedle comprises an elongated cylindrical needle shank, a first sloped portion that starts from the pointed end, and a second sloped portion that is provided between the first sloped portion and the needle shank. The angle of the first sloped portion is greater than the angle of the second sloped portion.

The axis shaft is a pogo pin.

In another embodiment, the radial grooves of one disc are arranged to be staggered with the radial grooves of the adjacent disc so that the microneedles of one disc are arranged to be staggered with the microneedles of the adjacent disc.

The radial groove comprises an inner end and an outer end. The outer end meets the circumference of the disc. The outer end has a tapered shape that becomes narrower toward the circumference of the disc.

In still another embodiment, a line connecting the inner end and the outer end of the radial groove is offset from the center of the disc.

The disc further comprises a recess for receiving bond. The bond is a UV bond.

The advantages of the present invention are: (1) the microneedle roller reduces pain in the skin substantially, and prevents wound in the skin; (2) the microneedle roller stimulates the skin uniformly; (3) the microneedle roller has excellent durability, and can reuse the handle; (4) the microneedle roller has good productivity since the time bonding the discs is reduced; and (4) the service life of the microneedle roller is extended since the microneedles do not fall off from the roller unit.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a microneedle roller according an embodiment of the present invention;

FIG. 2 is an exploded perspective view of a roller unit;

FIG. 3 is a perspective view of a disk;

FIG. 4 is an elevation view of a microneedle;

FIG. 5 is an enlarged perspective view of the microneedle, portion A of FIG. 3;

FIG. 6 is an elevation view of a disc according to another embodiment of the present invention; and

FIG. 7 is a perspective view of a roller unit according to still another embodiment of the invention.

### DETAILED DESCRIPTION OF THE INVENTION

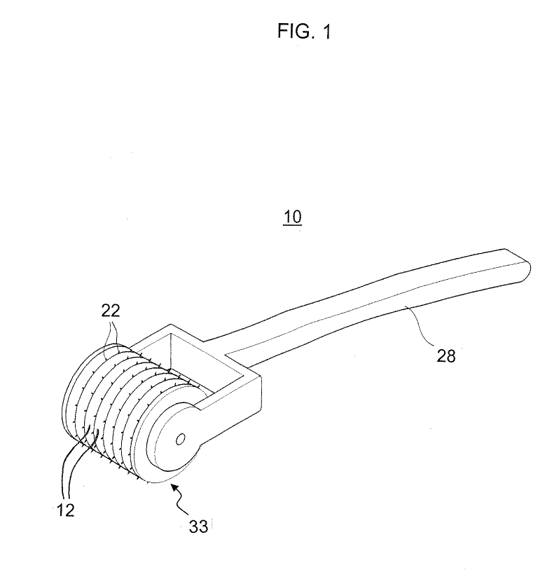

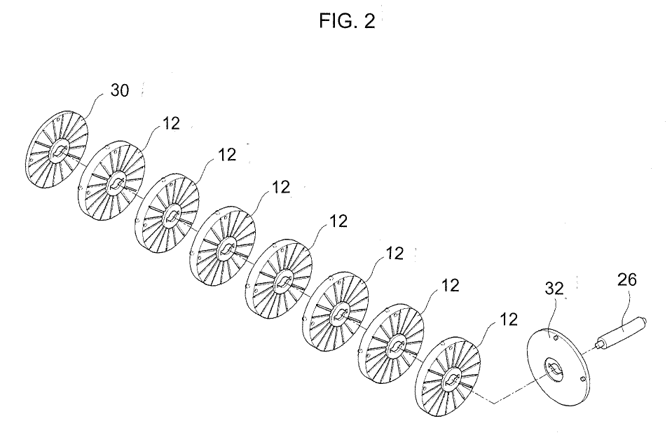

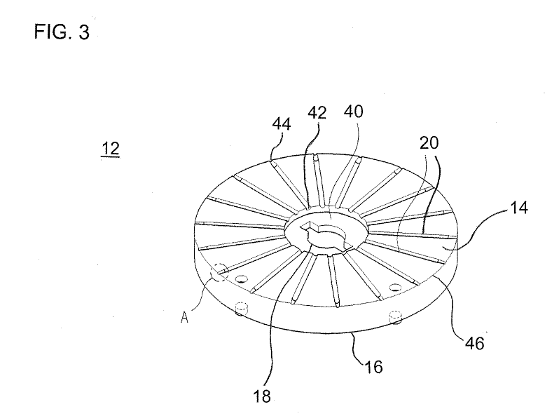

FIGS. 1 and 2 show a microneedle roller 10 that includes a plurality of discs 12, each of which comprises a first side surface 14, a second side surface 16 and a center hole 18 (refer to FIG. 3).

The first side surface 14 comprises a plurality of radial grooves 20, and the discs 12 are stacked on one another in a way that the first side surface 14 of one disc 12 contacts the second side surface 16 of the adjacent disc 12 as shown in FIG. 2.

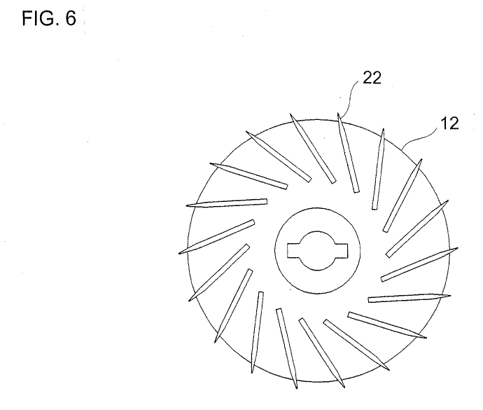

The microneedle roller 10 further includes a plurality of microneedles 22 that are received in the radial grooves 20 of the discs 12, and each of which has a pointed end 24 (refer to FIG. 5). The pointed end 24 protrudes beyond the circumference of the disc 12 as shown in FIG. 1.

The microneedle roller 10 further includes an axis shaft 26 that passes thorough the center holes 18 of the stacked discs 12 and a handle 28 that detachably supports both ends of the axis shaft 26. The discs 12, the microneedles 22, the axis shaft 26 and disc covers 30, 32 (refer to FIG. 2) form a roller unit 33. The disc covers 30, 32 are provided at the ends of the stacked discs 12. The discs 12 and the disc covers 30, 32 are rotated around the axis shaft 26.

The pointed end 24 of the microneedle 22 is rounded. The round shape of the pointed end of the microneedle reduces pain in the skin and increases durability of the microneedle 22. The rounded end is not broken in use and prevents wound in the skin.

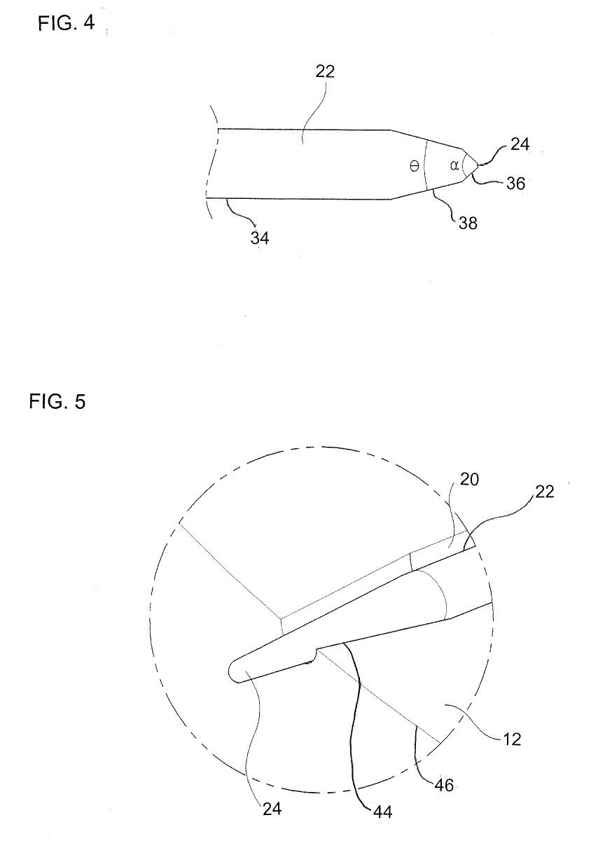

FIG. 4 shows that the microneedle 22 comprises an elongated cylindrical needle shank 34, a first sloped portion 36 that starts from the pointed end 24, and a second sloped portion 38 that is provided between the first sloped portion 36 and the needle shank 34. The angle of the first sloped portion, α is greater than the angle of the second sloped portion, θ. That is, the end of the microneedle 22 is more blunt than the portion that starts to be sharpened. Due to this shape, the microneedle 22 relieves pain in the skin.

Referring back to FIG. 2, the axis shaft 26 is a pogo pin that includes a spring provided inside. The spring elastically supports ends of the axis shaft 26, facilitating assembly and disassembly of the disc roller unit 33 with the handle 28.

The disc 12 further comprises a recess 40 for receiving bond in liquid state. The bond is used to combine the plurality of discs 12. The bond is a UV bond that is cured by ultraviolet ray. The UV bond has a clean bonding surface, and hardens very fast, from 5 to 15 seconds. The use of the UV bond reduces bonding time of the discs 12 thereby increasing the productivity.

Referring to FIG. 3, the radial groove 20 comprises an inner end 42 and an outer end 44. The outer end 44 meets the circumference 46 of the disc. FIG. 5 shows that the outer end 44 has a tapered shape that becomes narrower toward the circumference 46 of the disc 12. This narrowing shape of the radial groove 20 confines the microneedle 22 inside the radial groove 20 and prevents falling off of the microneedle 22 from the disc roller unit 33, thereby extending the service life of the microneedle roller 10.

FIG. 6 shows another embodiment of the present invention. A line connecting the inner end 42 and the outer end 44 of the radial groove 20 is offset from the center of the disc 12. By this scheme, the microneedle 22 can be protruded from the disc 12 with various angles other than vertical. This enables stimulating the skin in various ways, thus maximizing the effect of the microneedles.

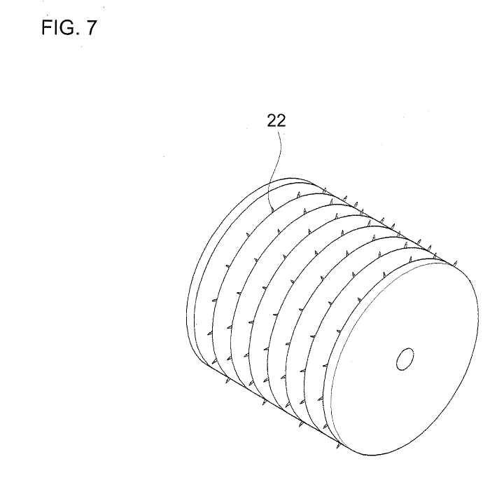

FIG. 7 shows still another embodiment of the present invention. The radial grooves 20 of one disc 12 are arranged to be staggered with the radial grooves 20 of the adjacent disc 12 so that the microneedles 22 of one disc 12 are arranged to be staggered with the microneedles 22 of the adjacent disc 12. The staggered arrangement of the microneedles avoids repetitive stimulation of the same spots on the skin but stimulates different points of the skin uniformly.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A microneedle roller comprising:
a) a plurality of discs, each of which comprises a first side surface, a second side surface and a center hole, wherein the first side surface comprises a plurality of radial grooves, wherein the discs are stacked on one another in a way that the first side surface of one disc contacts the second side surface of the adjacent disc;
b) a plurality of microneedles that are received in the radial grooves of the disc, and each of which has a pointed end, wherein the pointed end protrudes beyond the outer circumference of the disc;
c) an axis shaft that passes thorough the center holes of the stacked discs; and
d) a handle that detachably supports both ends of the axis shaft;
wherein the pointed end of the microneedle is rounded.

2. The microneedle roller of claim 1, wherein the microneedle comprises an elongated cylindrical needle shank, a first sloped portion that starts from the pointed end, and a second sloped portion that is provided between the first sloped portion and the needle shank, wherein the angle of the first sloped portion is greater than the angle of the second sloped portion.

3. The microneedle roller of claim 1, wherein the axis shaft is a pogo pin.

4. The microneedle roller of claim 1, wherein the radial grooves of one disc are arranged to be staggered with the radial grooves of the adjacent disc so that the microneedles of one disc are arranged to be staggered with the microneedles of the adjacent disc.

5. The microneedle roller of claim 4, wherein the radial groove comprises an inner end and an outer end, wherein the outer end meets the circumference of the disc, wherein the outer end has a tapered shape that becomes narrower toward the circumference of the disc.

6. The microneedle roller of claim 1, wherein the radial groove comprises an inner end and an outer end, wherein the outer end meets the circumference of the disc, wherein a line connecting the inner end and the outer end is offset from the center of the disc.

7. The microneedle roller of claim 6, wherein the outer end has a tapered shape that becomes narrower toward the circumference of the disc.

8. The microneedle roller of claim 1, wherein the disc further comprises a recess for receiving bond.

9. The microneedle roller of claim 1, wherein the bond is a UV bond.
